(19) United States
(12) Patent Application Publication
(10) Pub. No.: US 2012/0188362 A1
(43) Pub. Date: Jul. 26, 2012

(54) ELECTRONIC DEVICE AND IMAGING DEVICE

(75) Inventors: Aya TAKIMOTO, Osaka (JP); Hirotsugu Matsuura, Osaka (JP); Yuji Tominaga, Osaka (JP); Tadaaki Ito, Osaka (JP)

(73) Assignee: Panasonic Corporation, Osaka (JP)

(21) Appl. No.: 13/178,498

(22) Filed: Jul. 8, 2011

(30) Foreign Application Priority Data
Jan. 21, 2011 (JP) 2011-010817

(51) Int. Cl. H04N 7/18; G01L 9/00; G06F 19/00; G01B 21/18

(52) U.S. Cl. 348/81; 702/166; 702/50; 348/E07.085

(57) ABSTRACT

An electronic device is provided that includes a housing, an air pressure sensor, and controller. The housing is constructed of a water-tight structure and includes an air hole and a waterproof air-permeable membrane that block off the air hole. The air pressure sensor is disposed in the housing and configured to detect an air pressure value inside the housing. The controller is configured to calculate water pressure exerted on the housing and/or water depth of the housing based on the detected air pressure value inside the housing via the air pressure sensor.

### CROSS-REFERENCE TO RELATED APPLICATIONS

This application claims priority under 35 U.S.C. §119 to Japanese Patent Application No. 2011-10817, filed on Jan. 21, 2011. The entire disclosure of Japanese Patent Application No. 2011-10817 is hereby incorporated herein by reference.

### BACKGROUND

1. Technical Field

The technology disclosed herein relates to an electronic device and an imaging device equipped with an air pressure sensor.

2. Background Information

A method was known in the past for directly detecting water pressure by means of a water pressure sensor that is exposed from a housing having a water-tight structure (see, for example, Japanese Laid-Open Patent Application S55-140828).

With this method, however, a complicated attachment structure is employed so that the water pressure sensor can be exposed from the housing while still keeping water-tightness of the housing.

### SUMMARY

The technology disclosed herein was conceived in view of the conventional structure discussed herein above. Accordingly, one object of technology disclosed herein is to provide a device in which water pressure (water depth) and atmospheric pressure can be measured with a simple construction.

In accordance with one aspect of the technology disclosed herein, an electronic device is provided that includes a housing, an air pressure sensor, and controller. The housing is constructed of a water-tight structure and includes an air hole and a waterproof air-permeable membrane that block off the air hole. The air pressure sensor is disposed in the housing and configured to detect an air pressure value inside the housing. The controller is configured to calculate water pressure exerted on the housing and/or water depth of the housing based on the detected air pressure value inside the housing via the air pressure sensor.

With the technology disclosed herein, an electronic device and an imaging device can be provided with which water pressure (water depth) and atmospheric pressure can be measured with a simple construction.

These and other features, aspects and advantages of the present invention will become apparent to those skilled in the art from the following detailed description, which, taken in conjunction with the annexed drawings, discloses a preferred and example embodiments of the present invention.

### BRIEF DESCRIPTION OF DRAWINGS

Referring now to the attached drawings which form a part of this original disclosure:

FIG. 1 is a front oblique view of a digital camera pertaining to an embodiment;

FIG. 2 is a rear oblique view of a digital camera pertaining to the embodiment;

FIG. 3 is a front view of a housing pertaining to the embodiment;

FIG. 4 is a rear oblique view of a housing pertaining to the embodiment;

FIG. 5 is an exploded oblique view of a housing pertaining to the embodiment;

FIG. 6 is a cross section along the VI-VI line in FIG. 3;

FIG. 7 is a function block diagram of a digital camera pertaining to the embodiment;

FIG. 8 is a function block diagram of a controller pertaining to the embodiment; and

FIG. 9 is a flowchart illustrating the operation of a system-on-a-chip.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

In the following embodiments, a digital camera will be used as an example in describing an imaging device. In the following description, the following directional terms “front”, “rear”, “up”, “down”, “right”, and “left” are defined using as a reference a digital camera in a landscape orientation with respect to the subject. “Landscape orientation” is the orientation of a digital camera when the long-side direction of a rectangular image that is wider than it is tall substantially coincides with the horizontal direction in the image.

Simplified Configuration of Digital Camera 1

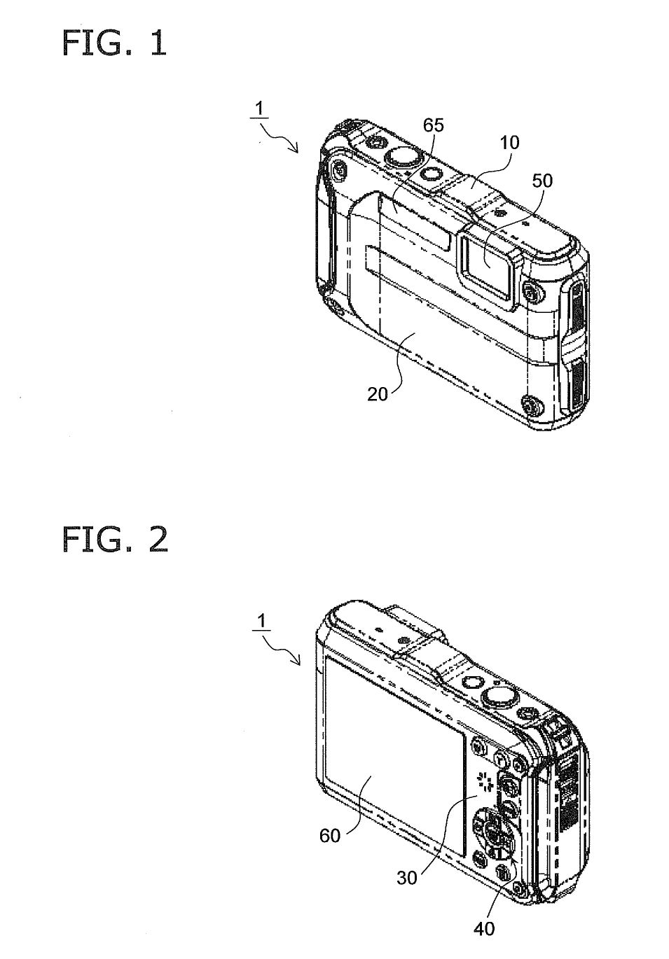

The simplified configuration of the digital camera 1 pertaining to the embodiment will be described through reference to the drawings. FIG. 1 is a front oblique view of the digital camera 1 pertaining to the embodiment. FIG. 2 is a rear oblique view of the digital camera 1 pertaining to the embodiment.

The digital camera 1 comprises a housing 10, a front cover 20, a rear cover 30, an operation unit 40, an optical system 50, a liquid crystal monitor 60, and a flash 65.

The housing 10 is a container that has a water-tight structure. The outer shape of the housing 10 deforms under water pressure when immersed in water. The amount of deformation of the housing 10 increases as a function of water depth. This housing 10 is preferably made from a material having flexibility and elasticity.

The front cover 20 is attached to the front face of the housing 10. The rear cover 30 is attached to the rear face of the housing 10. The operation unit 40 is attached to the rear face of the housing 10, and is exposed from the rear cover 30.

The operation unit 40 handles various inputs from the user. In this embodiment, the operation unit 40 handles the selection of the water depth measurement mode as one of the imaging modes. The optical system 50 is attached to the front face of the housing 10, and is exposed from the front cover 20. The optical system 50 lets external light into the interior of the housing 10 during imaging. The liquid crystal monitor 60 is attached to the rear face of the housing 10, and is exposed from the rear cover 30. Captured images are displayed on the liquid crystal monitor 60. The flash 65 is attached to the front face of the housing 10, and is exposed from the front cover 20.

Internal Configuration of Housing 10

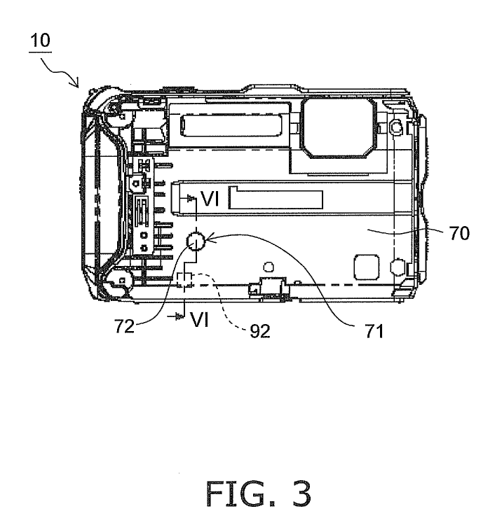

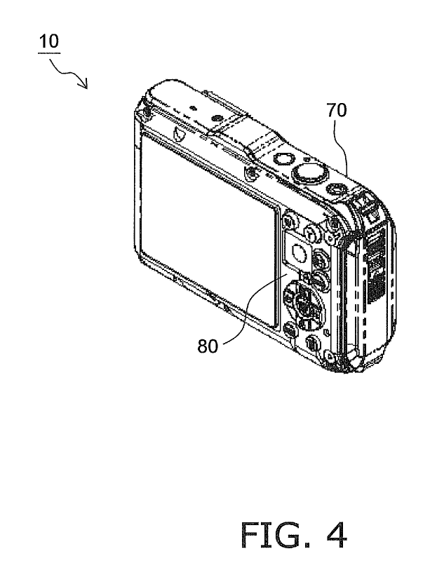

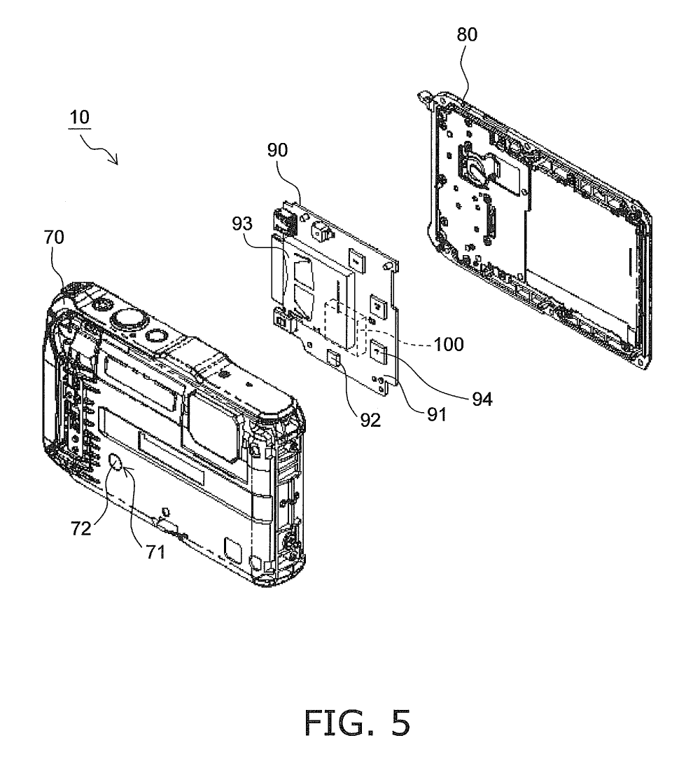

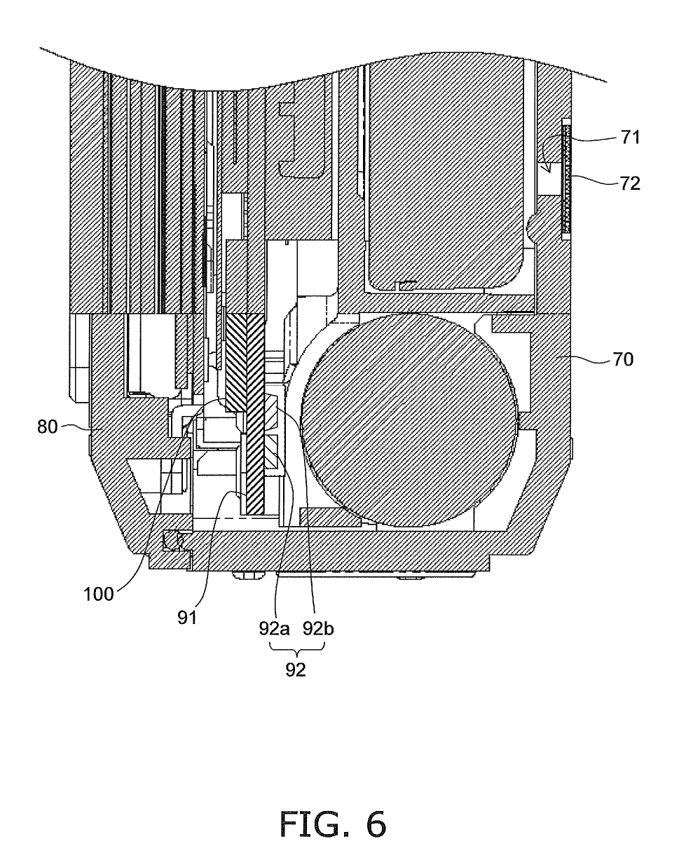

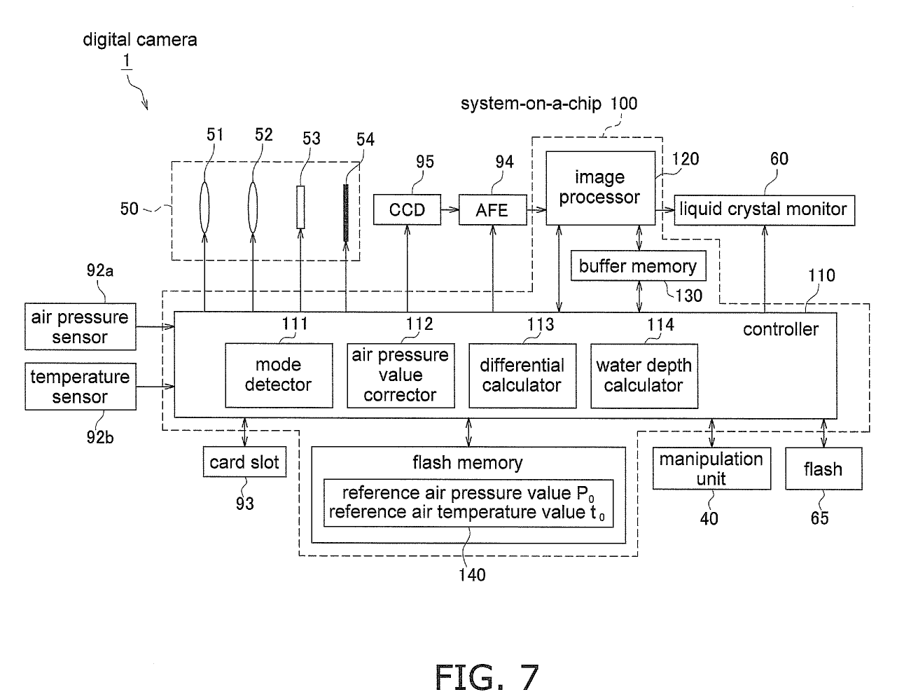

FIG. 3 is a front view of the housing 10 pertaining to the embodiment. FIG. 4 is a rear oblique view of the housing 10 pertaining to the embodiment. FIG. 5 is an exploded oblique view of the housing pertaining to the embodiment. FIG. 6 is a cross section along the VI-VI line in FIG. 3.

The housing 10 is constituted by a front plate 70 and a rear plate 80, and a control board 90 is disposed inside the housing 10. The front plate 70 and rear plate 80 fit snugly together to ensure t water-tightness of the housing 10. The control board 90 is sealed in between the front plate 70 and the rear plate 80 (that is, inside the housing 10).

The front plate 70 has an air hole 71 and a waterproof air-permeable membrane 72. The air hole 71 communicates between the inside and outside of the housing 10. The waterproof air-permeable membrane 72 blocks off the air hole 71. The waterproof air-permeable membrane 72 is made from a material that is permeable to air. Accordingly, when the digital camera 1 is located in the air, the internal pressure inside the housing 10 matches the atmospheric pressure. The waterproof air-permeable membrane 72 is made of a waterproof material. Accordingly, when the digital camera 1 is located in water, the infiltration of water through the air hole 71 is inhibited. Gore-Tex® (made by Japan Gore-Tex) can be used, for example, as the material of the waterproof air-permeable membrane 72.

A waterproof tape (not shown) is attached between the front plate 70 and the optical system 50 and flash 65. A gasket (not shown) is attached between the rear plate 80 and the operation unit 40 and liquid crystal monitor 60.

The control board 90 has a board main body 91; a sensor unit 92, a card slot 93, and an AFE (analog front end) 94 installed on the front face of the board main body 91; and a system-on-a-chip 100 installed on the rear face of the board main body 91.

The board main body 91 is a flat member on which various electronic parts can be installed.

As shown in FIG. 6, the sensor unit 92 has an air pressure sensor 92a and a temperature sensor 92b. The air pressure sensor 92a detects the internal pressure inside the housing 10. When the digital camera 1 is located in the air, the detected air pressure value P detected by the air pressure sensor 92a is in agreement with atmosphere pressure. When the digital camera 1 is located under water, the detected air pressure value P detected by the air pressure sensor 92a rises in proportion to the water depth of the housing 10, that is, in proportion to the decrease in volume inside the housing 10. The temperature sensor 92b detects the temperature inside the housing 10.

The card slot 93 is used to removably insert a memory card. The AFE 94 subjects image data produced by a CCD image sensor 95 (one example of an “imaging means” discussed below) to noise suppression processing, processing for amplification of the input range width of an A/D converter, A/D conversion processing, and so forth.

The system-on-a-chip 100 provides overall control over the operation of the various electronic parts comprised by the digital camera 1. The configuration of the system-on-a-chip 100 will be discussed below.

Functional Configuration of Digital Camera 1

FIG. 7 is a function block diagram showing the functional configuration of the digital camera 1 pertaining to the embodiment. In the following description, the configuration other than that discussed above will mainly be described.

The optical system 50 has a focus lens 51, a zoom lens 52, an aperture 53, and a shutter 54. The focus lens 51 adjusts the focas state of the subject. The zoom lens 52 adjusts the field angle of the subject. The aperture 53 adjusts the amount of light incident on the CCD image sensor 95. The shutter 54 adjust the exposure time of the light incident on the CCD image sensor 95. The focus lens 51, the zoom lens 52, the aperture 53, and the shutter 54 are each driven by a DC motor, a stepping motor, or another such drive unit according to a command signal send from a controller 110.

The CCD image sensor 95 is an example of the “imaging means” pertaining to the embodiment. The CCD image sensor 95 produces image data by opto-electrical conversion.

The system-on-a-chip 100 has the controller 110, an image processor 120, a buffer memory 130, and a flash memory 140.

The controller 110 provides overall control of the operation of the entire digital camera 1. The controller 110 is constituted by a ROM, a CPU, etc. The ROM contains programs for file control, autofocus control (AF control), automatic exposure control (AE control), and operational control over the flash 65, as well as programs for the overall control of the operation of the entire digital camera 1.

In this embodiment, the controller 110 has a mode detector 111, an air pressure value corrector 112, a differential calculator 113, and a water depth calculator 114. The controller 110 calculates water depth D of the housing 10 on the basis of the detected air pressure value P detected by the air pressure sensor 92a when the user has selected the water depth measurement mode with the operation unit 40. Here, the controller 110 reads out a reference air pressure value P₀ and a reference air temperature value t₀ from the flash memory 140. The functional configuration and operation of the controller 110 will be discussed below.

The controller 110 can also be constituted by a hard-wired electronic circuit or a microprocessor that executes programs.

The image processor 120 subjects the image data that has undergone various processing by the AFE 94 to white balance correction, color reproduction correction, gamma correction, smear correction, YC conversion processing, electronic zoom processing, and other such processing. In this embodiment, the image processor 120 subjects the image data to white balance correction, color reproduction correction, and gamma correction when the water depth value D of the housing 10 exceeds a specific water depth (such as about 3 meters). Here, the image processor 120 performs the white balance correction, color reproduction correction, and gamma correction so as to minimize an increase in blueness in the captured image (that is, a decrease in redness in the captured image).

The image processor 120 can also be constituted by a hard-wired electronic circuit or a microprocessor that executes programs.

The buffer memory 130 is a volatile storage medium that functions as a working memory for the controller 110 and the image processor 120. In this embodiment, the buffer memory 130 is a DRAM.

The flash memory 140 is an internal memory of the digital camera 1. The flash memory 140 is a non-volatile storage medium. In this embodiment, the reference air pressure value P₀ and reference air temperature value t₀ are stored in the flash memory 140.

Measuring Water Depth Value D from Detected Air Pressure Value P

The waterproof air-permeable membrane 72 blocks off the air hole 71 in the digital camera 1. When atmospheric pressure changes occur in the atmosphere, the internal pressure inside the housing 10 is changed in accordance with the atmospheric pressure due to the air permeability of the waterproof air-permeable membrane 72. Consequently, the air pressure inside the housing 10 is equal to the atmospheric pressure.

Then the digital camera 1 is gradually lowered in altitude and the air pressure inside the housing 10 becomes substantially equal to the atmospheric pressure at the altitude of the water surface just after the digital camera 1 drops under a water surface. After this, as the camera is submerged in the water, there is no change in the air pressure inside the housing 10, assuming the housing 10 is not deformed by water pressure. In actual practice, however, the housing 10 of the digital camera 1 is gradually deformed by the water pressure, which increases along with the water depth. This deformation is accompanied by a gradually rise in the air pressure inside the housing 10. The external water pressure (the water depth value D) can be estimated by measuring the air pressure change inside the housing 10. This is how the water depth value D is measured (estimated) with the digital camera 1 in this embodiment.

Specifically, air pressure change inside the housing 10 attributable to deformation of the housing 10 by water pressure is measured by the air pressure sensor 92a, and the water pressure (the water depth value D) can be estimated on the basis of this air pressure change. The relation between the air pressure change inside the housing 10 and the water pressure (the water depth value D) can be approximated by a specific nonlinear function (hereinafter referred to as a “water depth calculation function”).

Functional Configuration of Controller 110

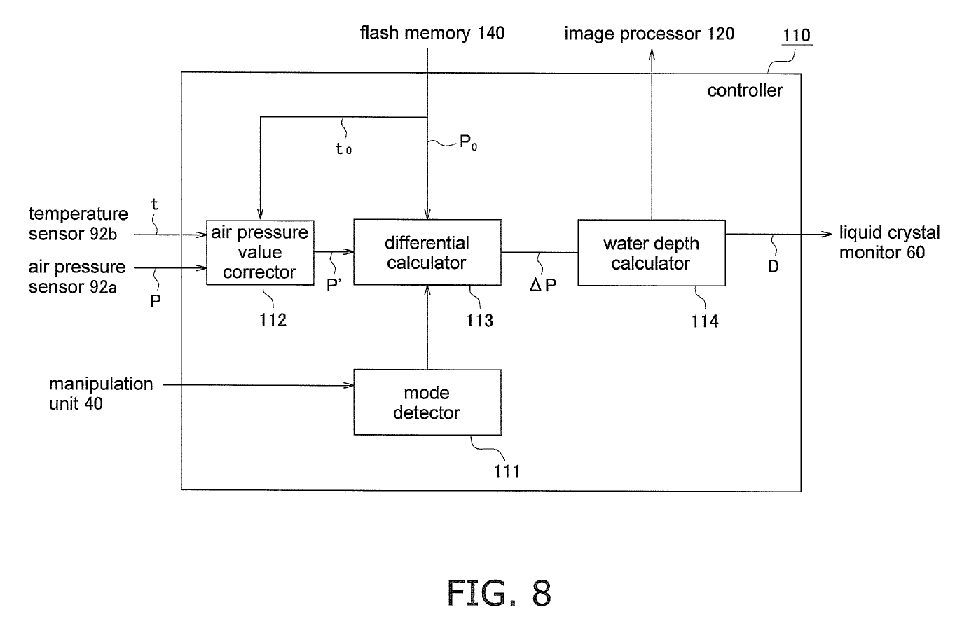

FIG. 8 is a function block diagram of the functional configuration of the controller 110 pertaining to the embodiment.

The controller 110 has the mode detector 111, the air pressure value corrector 112, the differential calculator 113, and the water depth calculator 114.

The mode detector 111 decides whether or not the camera is in water depth measurement mode. Setting and unsetting of the water depth measurement mode are performed with the operation unit 40. If the mode detector 111 decides that the camera is in water depth measurement mode, a notification to that effect is sent to the air pressure value corrector 112.

The air pressure value corrector 112 performs temperature correction on the detected air pressure value P detected by the air pressure sensor 92a on the basis of the reference air temperature value t₀ stored in the flash memory 140 and the detected temperature value t detected by the temperature sensor 92b. More specifically, the air pressure value corrector 112 calculates the corrected air pressure value P′ from the following formula (1).

P′=P×(273.2+t₀)÷(273.2+t) (1)

The differential calculator 113 calculates the differential ΔP between the reference air pressure value P₀ stored it the flash memory 140 and the corrected air pressure value P′ calculated by the air pressure value corrector 112. This differential ΔP is the relative amount of change in air pressure relative to the reference air pressure value P₀.

The water depth calculator 114 calculates the water depth value D on the basis of the differential ΔP found by a differential detector 102 and the water depth calculation function. The water depth calculator 114 displays the calculated water depth value D on the liquid crystal monitor 60. Also, the water depth calculator 114 notifies the image processor 120 when the calculated water depth value D exceeds the specific water depth (such as about 3 meters). The image processor 120 subjects the image data to white balance correction, color reproduction correction, and gamma correction according to the notification from the water depth calculator 114.

Operation of System-on-a-Chip 100

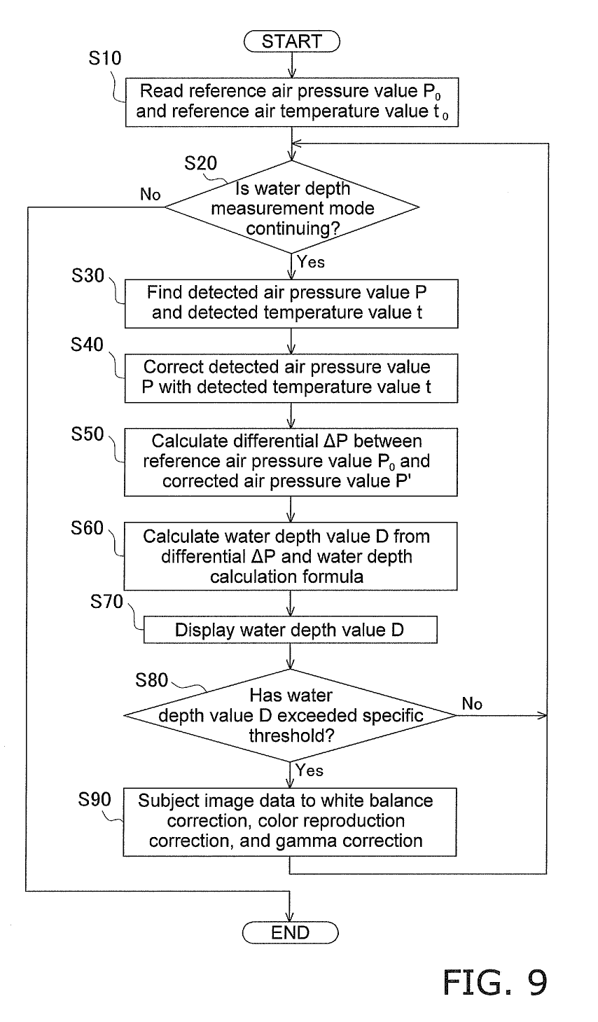

The operation of the system-on-a-chip 100 pertaining to the embodiment will be described through reference to the drawings. FIG. 9 is a flowchart illustrating the operation of the system-on-a-chip 100. In the following description, we will assume that the water depth measurement mode has been detected by the mode detector 111.

In step S10, the controller 110 reads the reference air pressure value P₀ and reference air temperature value t₀ stored in the flash memory 140.

In step S20, the controller 110 decides whether or not the water depth measurement mode is continuing. If the water depth measurement mode is continuing, the processing proceeds to step S30. If the water depth measurement mode has been switched off by the mode detector 111, the water depth measurement processing is ended.

In step S30, the controller 110 detects the detected air pressure value P outputted from the air pressure sensor 92a, and the detected temperature value t outputted from the temperature sensor 92b.

In step S40, the controller 110 finds the temperature-corrected air pressure value P′ from the reference air temperature value t₀ read in step S10 and the detected air pressure value P and the detected temperature value t detected in step S30.

In step S50, the system-on-a-chip 100 calculates the differential ΔP between the reference air pressure value P₀ read in step S10 and the temperature-corrected air pressure value P′ calculated in step S40.

In step S60, the controller 110 finds the water depth value D by using the water depth calculation function and the differential ΔP found in step S50.

In step S70, the controller 110 displays the water depth value D found in step S60 on the liquid crystal monitor 60.

In step S80, the controller 110 decides whether or not the water depth value D found in step S60 exceeds the specific water depth (such as about 3 meters). If the specific water depth is exceeded, the processing proceeds to step S90. If the specific water depth is not exceeded, the processing proceeds to step S20.

In step S90, the image processor 120 performs white balance correction, color reproduction correction, and gamma correction on the image data.

### EFFECTS OF THE INVENTION

(1) With the digital camera 1 pertaining to the embodiment, the housing 10 with a water-tight structure has the waterproof air-permeable membrane 72 that blocks off the air hole 71. The controller 110 calculates the water depth value D of the housing 10 on the basis of the detected air pressure value P detected by the air pressure sensor 92a inside the housing 10.

Since the air pressure sensor 92a is thus disposed inside the housing 10, there is no need for the air pressure sensor 92a to be exposed from the housing 10. Also, since the water depth value D can be measured from the detection result of the air pressure sensor 92a, there is no need to provide a water pressure sensor separate from the air pressure sensor 92a. Furthermore, since the air hole 71 is blocked off by the waterproof air-permeable membrane 72, when the housing 10 is located in the air, the atmospheric pressure can be detected by the air pressure sensor 92a. The above allows water depth and atmospheric pressure to be measured with a simple construction.

(2) The controller 110 has the differential calculator 113 that calculates the differential ΔP between the reference air pressure value P₀ and the corrected air pressure value P′, and the water depth calculator 114 that calculates the water depth value D on the basis of the differential ΔP.

Therefore, the controller 110 can easily calculate the water depth value D according to the relative amount of change in air pressure using the reference air pressure value P₀ as a reference.

(3) The differential calculator 113 calculates the differential ΔP when the selection of the water depth measurement mode has been detected. Therefore, there is no need to provide a function for automatically detecting entry into water, so water depth and atmospheric pressure can be measured with a simpler construction.

(4) The differential calculator 113 uses a specific value as the reference air pressure value P₀. Therefore, there is no need to calculate or detect the reference air pressure value P₀, so calculation processing for the water depth value D can be begun quickly and easily.

(5) The controller 110 has the air pressure value corrector 112 that corrects the detected air pressure value P on the basis of the detected temperature value t obtained from the temperature sensor 72b. The differential calculator 113 uses the detected air pressure value P′ corrected by the air pressure value corrector 112.

Therefore, air temperature changes inside the housing 10 result in fewer errors in the water depth value D, so the water depth value D can be calculated more accurately.

(6) The digital camera 1 comprises the image processor 120 that subjects image data to correction on the basis of the water depth value D calculated by the controller 110. The image processor 120 performs white balance correction, color reproduction correction, and gamma correction when the water depth value D has exceeded the specific water depth.

These corrections minimize an increase in blueness in the captured image, so the quality of a captured image can be improved.

### Other Embodiments

The present invention is described by the embodiment above, but this should not be interpreted to mean that the text and drawings that form part of this disclosure limit this invention. Various substitute embodiments, working examples, and implementation techniques will probably be obvious to a person skilled in the art from this disclosure.

(A) In the above embodiment, the controller 110 began calculation processing for the water depth value D when the user has selected the water depth measurement mode, but this is not the only option. The calculation of the water depth value D may be begun when entry of the housing 10 into water has been detected if the digital camera 1 comprises a water entry detector for detecting the entry of the housing 10 into water. In this case, since entry into water can be detected automatically, the water depth value D can be measured more accurately than when the calculation processing for the water depth value D is begun in response to operation by the user. Furthermore, the controller 110 may have a water entry detector that detects the entry of the housing 10 into water in response to a change in voltage between a pair of electrodes provided on the outer surface of the housing 10.

(B) In the above embodiment, the controller 110 used specific values stored in the flash memory 140 as the reference air pressure value P₀ and the reference air temperature value t₀, but this is not the only option.

For example, the controller 110 may use as the reference air pressure value P₀ the detected air pressure value P when selection of the water depth measurement mode has been detected. In this case, the water depth value D can be calculated by referring to how high the atmospheric pressure is at the point when calculation processing is started for the water depth value D. Accordingly, the water depth value D can be calculated more accurately.

Also, the controller 110 may use as the reference air pressure value P₀ the detected air pressure value P when entry of the housing 10 into water has been detected by the above-mentioned water entry detector. In this case, the detected air pressure value P at the point of water entry can be used as a reference, so the water depth value D can be calculated more accurately.

Furthermore, the controller 110 may use as the reference air pressure value P₀ the detected air pressure value P at a point in time designated by the user. In this case, the point of water entry can be accurately ascertained even if the above-mentioned water entry detector is not provided, so the water depth value D can be calculated more accurately.

(C) In the above embodiment, the image processor 120 performed white balance correction, color reproduction correction, and gamma correction when the water depth value D exceeded the specific water depth, but this is not the only option. For example, the image processor 120 may gradually increase the strength of the white balance correction, color reproduction correction, and gamma correction as the water depth value D becomes larger. In this case, since the correction strength can be altered according to the water depth value D, the quality of a captured image can be further improved.

Also, the image processor 120 may perform just one correction from among white balance correction, color reproduction correction, and gamma correction in order to minimize the increase in blueness of the captured image.

(D) In the above embodiment, the water depth calculator 114 calculated by the water depth value D, but this is not the only option. The water depth calculator 114 may calculate a “water pressure value” instead of the water depth value D. This “water pressure value” can be calculated from the water depth calculation function described in the above embodiment, or a similar function.

(E) In the above embodiment, the digital camera 1 (an example of an “imaging device”) was given as an example of an “electronic device,” but this is not the only option. Examples of the “electronic device” include video cameras, portable telephones, IC recorders, and so forth.

Thus, the present invention of course includes various embodiments and the like that are not discussed herein. Therefore, the technological scope of the present invention is not limited to just the specific inventions pertaining to the appropriate claims from the descriptions given above.

### General interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a electronic device and an imaging device. Accordingly, these terms, as utilized to describe the present invention should be interpreted relative to a electronic device and an imaging device.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An electronic device comprising:
a housing constructed of a water-tight structure, the housing including an air hole and a waterproof air-permeable membrane blocking off the air hole;
an air pressure sensor disposed in the housing and configured to detect an air pressure value inside the housing; and
a controller configured to calculate water pressure exerted on the housing and/or water depth of the housing based on the detected air pressure value inside the housing via the air pressure sensor.

2. The electronic device according to claim 1, wherein
the controller includes
a differential calculator configured to calculate the difference between the detected air pressure value and a reference air pressure value, and
a water depth calculator configured to calculate the water pressure and/or the water depth based on the difference between the detected air pressure value and the reference air pressure value.

3. The electronic device according to claim 2, wherein
the controller further includes a mode detector configured to detect a water depth measurement mode selected by a user, and
the differential calculator being configured to calculate the difference between the detected air pressure value and the reference air pressure value when the water depth measurement mode has been detected by the mode detector.

4. The electronic device according to claim 2, wherein
the controller further includes a water entry detector configured to detect when the housing has been disposed in water, and
the differential calculator being configured to calculate the difference between the detected air pressure value and the reference air pressure value when the water entry detector has detected that the housing has been disposed into water.

5. The electronic device according to claim 2, wherein
the reference air pressure value is a specific value used by the differential calculator.

6. The electronic device according to claim 3, wherein
the reference air pressure value is detected by the air pressure sensor at or around the time when the water depth measurement mode has been detected by the mode detector.

7. The electronic device according to claim 4, wherein
the reference air pressure value is detected by the air pressure sensor at or around the time when the water entry detector has detected that the housing has been disposed into water.

8. The electronic device according to claim 2, further comprising
a temperature sensor disposed in the housing and configured to detect an air temperature value inside the housing, wherein
the controller further includes an air pressure value corrector configured to correct the detected air pressure value based on the detected air temperature value by the temperature sensor,
the corrected air pressure value obtained by the air pressure value corrector being used by the differential calculator.

9. An imaging device comprising:
a housing constructed of a water-tight structure;
an air pressure sensor disposed in the housing and configured to detect an air pressure value inside the housing;
a controller configured to calculate water pressure exerted on the housing and/or water depth of the housing based on the detected air pressure value inside the housing via the air pressure sensor; and
an imaging element configured to produce image data by opto-electrical conversion.

10. The imaging device according to claim 9, further comprising
an image processor configured to subject the image data to at least one of white balance correction, color reproduction correction, and gamma correction based on the water pressure exerted on the housing and/or the water depth of the housing calculated via the controller.
